(19) United States
(12) Patent Application Publication
(10) Pub. No.: US 2023/0205326 A1
(43) Pub. Date: Jun. 29, 2023

(54) ERGONOMIC COMPUTER MOUSE

(71) Applicant: Jonathan CUI, Jericho, NY (US)

(72) Inventor: Jonathan CUI, Jericho, NY (US)

(21) Appl. No.: 17/564,848

(22) Filed: Dec. 29, 2021

(51) Int. Cl. G06F 3/0354

(52) U.S. Cl. CPC G06F 3/03543

(57) ABSTRACT

A computer mouse device including a housing including a base. The base includes a sensing surface adapted to contact and traverse over a support surface. The sensing surface forms a sensing surface plane having a base axis Y-Y extending orthogonally through the sensing surface plane. The housing includes a plurality of user input devices thereon adapted for generating an input to a computing device. A sensor is disposed on the base and has a sensing element disposed adjacent the support surface. The sensor generates a motion signal responsive to a movement of the housing. The housing includes an output device adapted to be operably connected to the computing device for communicating the motion signal to the computing device. The housing further includes an elongate handle extending from the base toward a handle distal end. The housing further includes an elongate handle extending from the base downwardly toward the sensing surface plane toward a handle distal end.

### FIELD OF TECHNOLOGY

The present disclosure relates to a computer mouse for controlling a computer, and more specifically to a computer mouse having an ergonomic configuration.

### BACKGROUND

A user computer input device known as a computer mouse is well known in the art. The mouse typically includes a sensing portion that converts movement of the mouse into a signal, which in turn moves an indicator or cursor on a computer screen. The mouse is a common way for users to control computer software functionality. A mouse device also typically includes one or more user input devices, such as buttons or wheels that permit a user to make a selection or otherwise interface with and control the computer. The mouse has become an integral piece of hardware for a computer. As users spend ever-increasing amounts of time on the computer, the use of the mouse has increased.

Since the mouse device is moved by a user's hand, such use over long periods can lead to tendinitis or bursitis in the hand, and cause pain and strain in the hand, wrist, and/or arm. In order to address these conditions, a number of mouse designs have been introduced in order to be more ergonomic. However, such designs can still require the hand and arm to assume unnatural positions causing strain and discomfort over long periods of use. The placement of the buttons and wheels can also cause undue stress.

Accordingly, it would be desirable to provide a mouse device that permits a user to manipulate the mouse device for long periods of time without causing undue pain.

### SUMMARY

The present disclosure provides a computer mouse device including a housing including a base. The base includes a sensing surface adapted to contact and traverse over a support surface. The sensing surface forms a sensing surface plane having a base axis Y-Y extending orthogonally through the sensing surface plane. The housing includes a plurality of user input devices thereon adapted for generating an input to a computing device. A sensor is disposed on the base and has a sensing element disposed adjacent the support surface. The sensor generates a motion signal responsive to a movement of the housing. The housing includes an output device adapted to be operably connected to the computing device for communicating the motion signal to the computing device. The housing further includes an elongate handle extending from the base downwardly toward the sensing surface plane toward a handle distal end.

The present disclosure further provides a computer mouse device including a housing including a base. The base includes a sensing surface adapted to contact and to traverse over a support surface. The sensing surface forms a sensing surface plane having a base axis Y-Y extending orthogonally through the sensing surface plane. The housing includes at least one user input devices thereon adapted for generating an input to control a computing device. A sensor is disposed on the base and has a sensing element disposed adjacent the support surface. The sensor generates a motion signal responsive to a movement of the housing. The housing includes an output device adapted to be operably connected to the computing device for communicating the motion signal to the computing device. The housing further includes an elongate handle extending from the base toward a handle distal end. The handle curves relative to the base axis as it extends from the base toward the distal end.

The disclosure still further provides a housing including a base having a sensing surface adapted to contact and to traverse over a support surface. The sensing surface forms a sensing surface plane having a base axis Y-Y extending orthogonally through the sensing surface plane. The housing includes a first user input device thereon adapted for generating an input signal adapted to control a computing device upon operation by a user. A sensor is disposed on the base and has a sensing element disposed adjacent the support surface. The sensor generates a motion signal responsive to a movement of the housing. The housing includes an output device adapted to be operably connected to the computing device for communicating the motion signal to the computing device. The housing further includes an elongate handle extending from the base toward a handle distal end. The handle distal end has a distal surface that lies on the sensing surface plane. The handle extending downwardly toward the sensing surface plane along a first handle axis as the handle extends from the base toward the distal end. The handle curves along a second handle axis orthogonal to the first handle axis as the handle extends from the base toward the distal end.

Features of the disclosure will become apparent from the following detailed description considered in conjunction with the accompanying drawings. It is to be understood, however, that the drawings are designed as an illustration only and not as a definition of the limits of this disclosure.

### BRIEF DESCRIPTION OF THE DRAWINGS

FIG. 1 is an isometric top view of one embodiment of a computer mouse of the present disclosure.

FIG. 2 is an isometric bottom view thereof.

FIG. 3 is a front elevational view thereof.

FIG. 4 is a left side view thereof.

FIG. 5 is a rear elevational view thereof.

FIG. 6 is a right side view of thereof.

FIG. 7 is a top plan view thereof.

FIG. 8 is a bottom elevational view thereof.

FIG. 9 is a schematic view of a motion sensor.

FIG. 10 is an isometric top view of another embodiment of a computer mouse of the present disclosure.

FIG. 11 is a front elevational view thereof.

FIG. 12 is a rear elevational view thereof.

FIG. 13 is a left side view thereof.

FIG. 14 is a right side view of thereof.

FIG. 15 is a top plan view thereof.

FIG. 16 is a bottom elevational view thereof.

### DETAILED DESCRIPTION

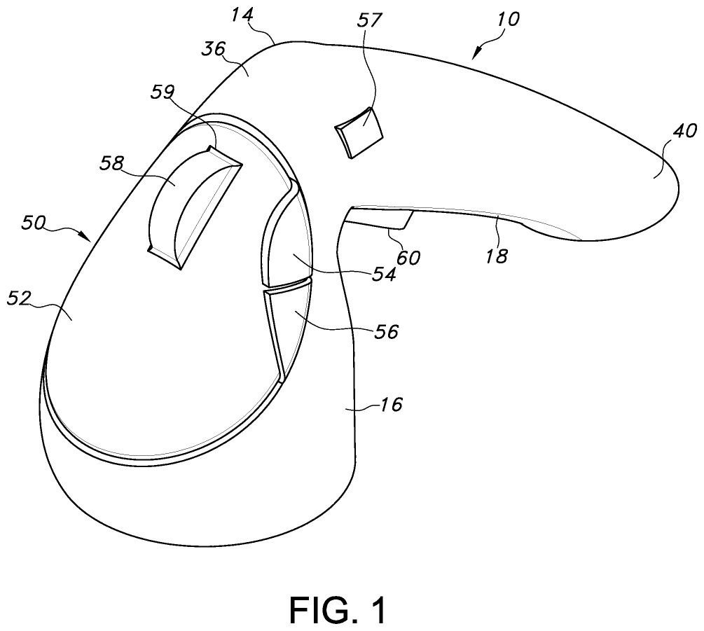

With reference to FIGS. 1-3, the present disclosure includes an ergonomic computer mouse device 10 for controlling a computing device. The mouse is operably connected to the computing device by a wire 12 or wirelessly in a manner known in the art. The mouse includes a housing 14 having a base 16 and an elongate handle 18 extending therefrom.

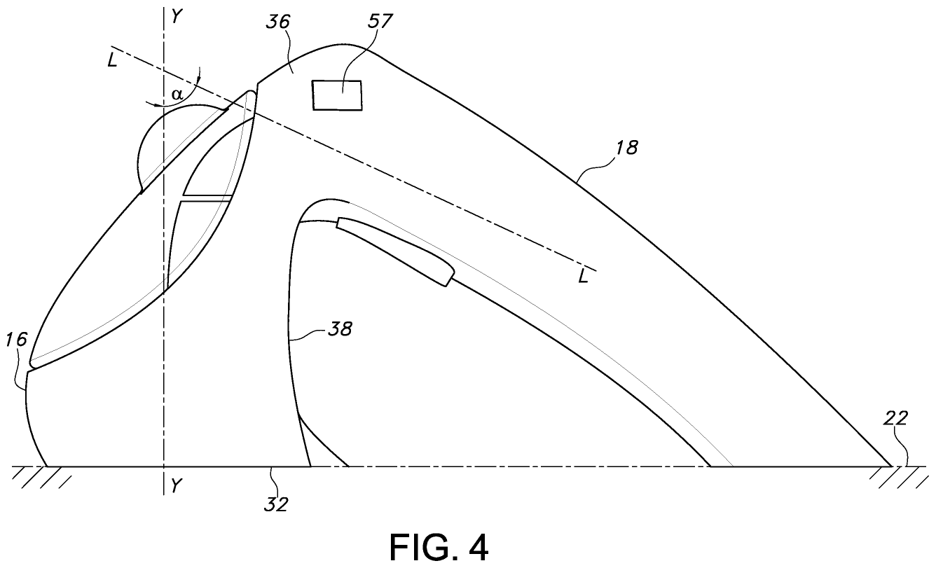

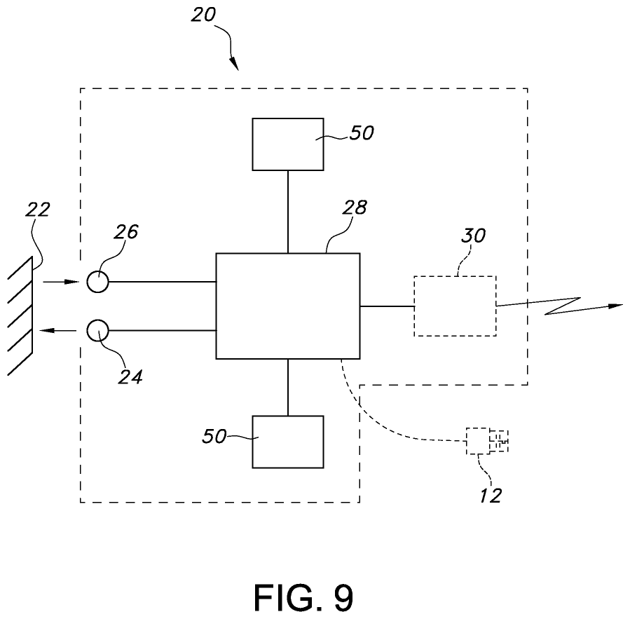

With additional reference to FIGS. 4 and 9, the housing 14 includes within a motion sensor 20 that generates a signal responsive to the movement of the mouse device 10. The sensor 20 may be of a type known in the art. For example, the sensor 20 may be an optical sensor, or a mechanical ball-type sensor, or other type of sensing device known the art. In an optical sensor, the sensor emits light down onto support surface 22 from an LED 24 (light-emitting diode), mounted on the bottom of the mouse device 10. The light bounces straight back up off the support surface 22 into a photoelectric cell 26, also mounted under the mouse, adjacent the LED. As the mouse device 10 is moved, the pattern of reflected light changes, and a processor 28 inside the mouse converts the analog movements of the user's hand into digital signals that are transmitted to the computing device. The transmission of the signals may be via a wire with a connector 12 or a wireless communication module 30 of a type known in the art. Such wireless communication modules 30 may include a radio frequency transmitter and operate under a communication standard or protocol such as Bluetooth or Wi-Fi. The computing device would have a compatible communication receiver as is know in the art to communicate with the module 30.

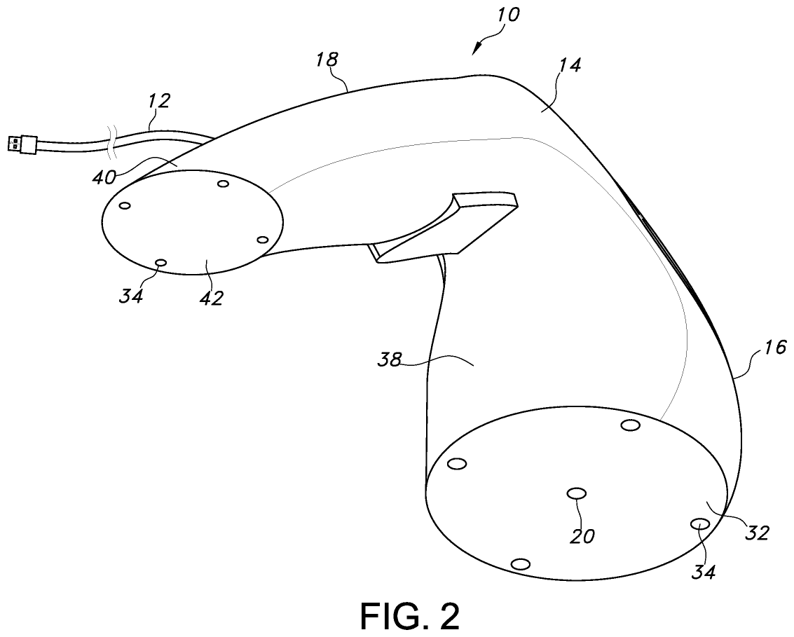

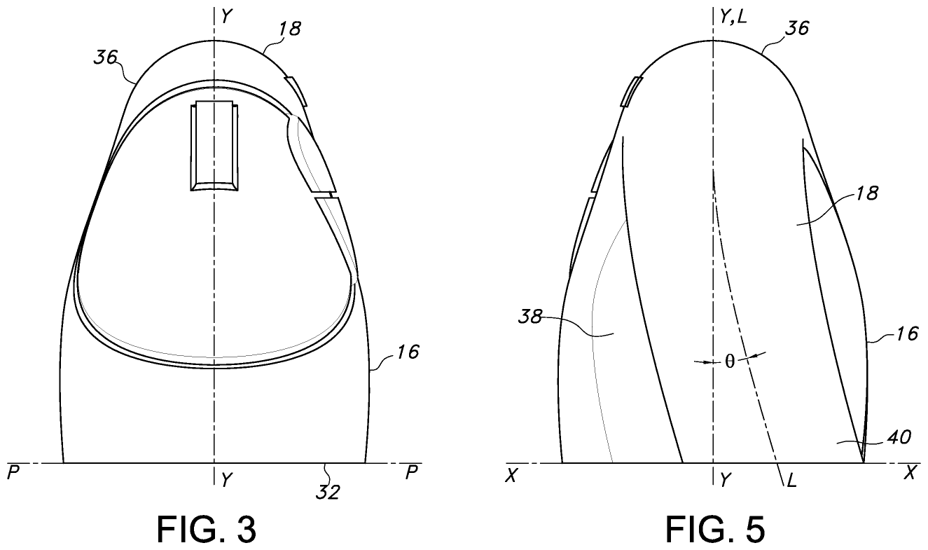

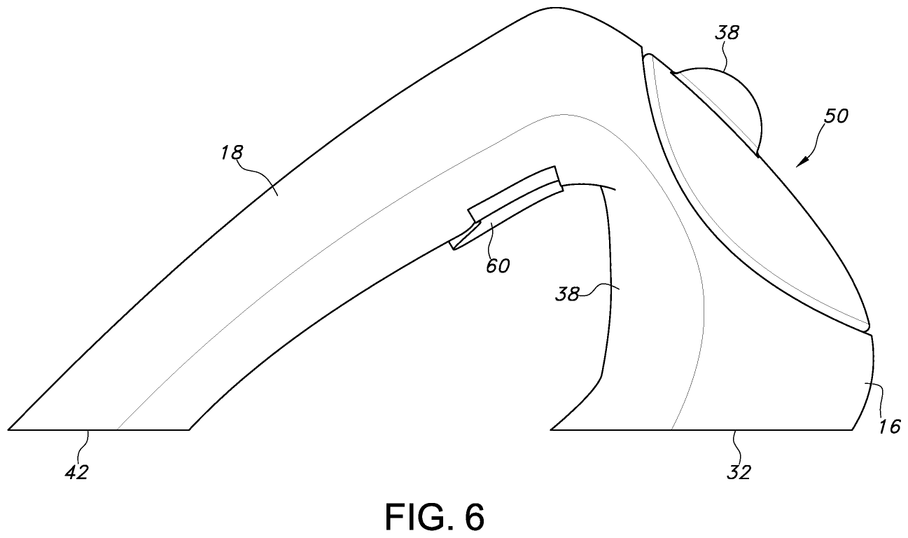

With reference to FIGS. 4-6, the housing base 16 includes a sensing surface 32 adapted to contact and traverse over the support surface 22. The sensing surface 32 may have a round configuration as show in FIGS. 2 and 3. However, it is contemplated that the configuration of the sensing surface 32 may be formed in a variety of shapes. The sensing surface 32 lies in a plane P having a base axis Y-Y extending orthogonally therethrough. The base axis Y-Y extends along a direction of the height of the base. The sensor 20 is disposed in the housing adjacent the sensing surface. The sensing surface 32 is adapted to slide over the support surface 22 such as a mouse pad, for example. The sensing surface 32 may include friction-reducing pads 34 secured thereto to assist the mouse to be moved along the support surface 22. The pads 34 may be formed of a low friction material such as a hard plastic such as nylon PTFE or alternatively a soft felt-like material to assist sliding over the support surface 22.

The base 16 narrows as it extends upwardly from the sensing surface 32 to its upper portion 36. A back side of the base has a concave surface 38, which accommodates a user's fingers as the handle is engaged. The elongate handle 18 extends from the base upper portion and provides a gripping element for the user to hold and manipulate the mouse device 10. The handle 18 may have a generally round cross-section to facilitate the comfortable engagement by a user. The handle 18 extends along a longitudinal axis L-L from the base 16 toward a handle distal end 40. The distal end 40 has planar distal surface 42 that lies in the same plane P as the sensing surface 32. Accordingly, the mouse 10 is supported by both the sensing surface 32 and distal surface 42 on the support surface 22 when the mouse 10 is in use. By supporting the mouse device 10 at two spaced locations, stress on the users hand and arm is reduced.

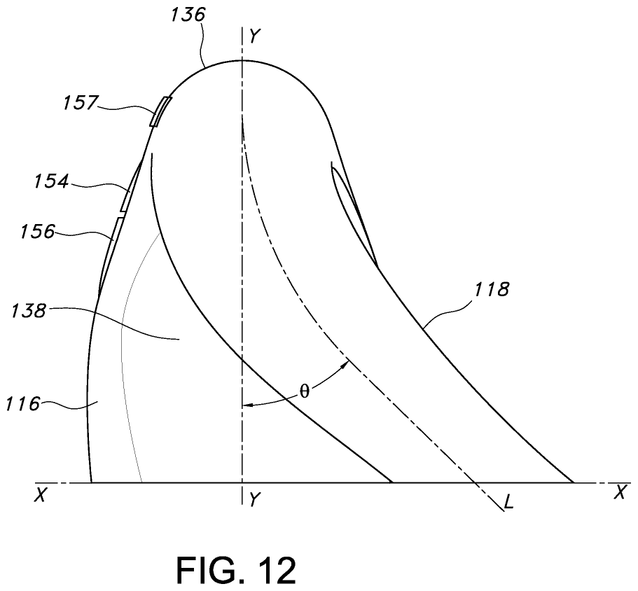

With reference to FIGS. 3-6, the handle 18 curves both downwardly and laterally as it extends from the base 16 to the distal end 40. Thus, the handle curvature is along two distinct axes. One degree of curvature is relative to an axis X-X lying along the sensing plane P as shown in FIG. 12. A second degree of curvature is relative to the base axis Y-Y, which is orthogonal to the X-X axis as shown in FIG. 4. In other words, the handle 18 curves downwardly toward plane P (curvature in the Y axis) and curves laterally (curvature in the X axis) when viewed from the back or front of the mouse 10. The curvature of the handle 18 thus is helical-like in shape as it curves to a side in an arcuate manner as it extends downwardly. This curvature conforms to a comfortable ergonomic orientation of a user's hand and arm, thereby permitting ease of mouse 10 operation over long periods of time.

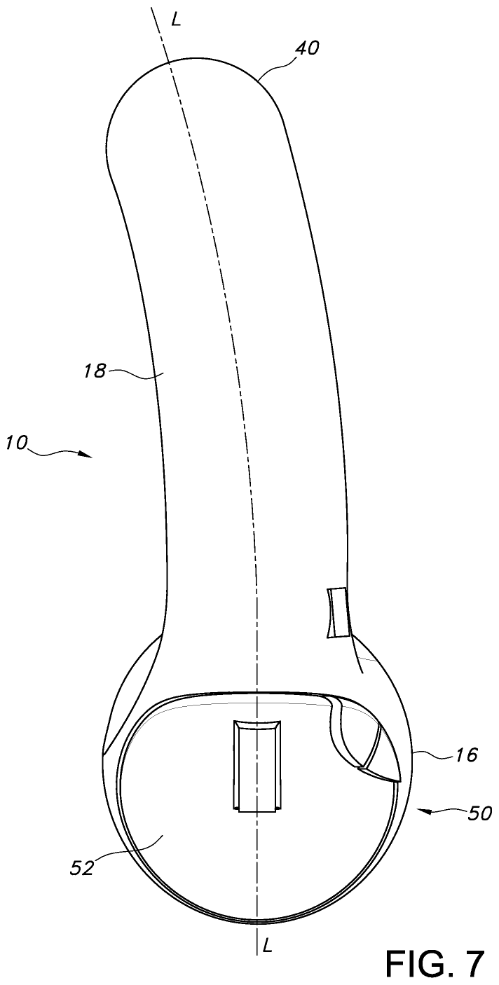

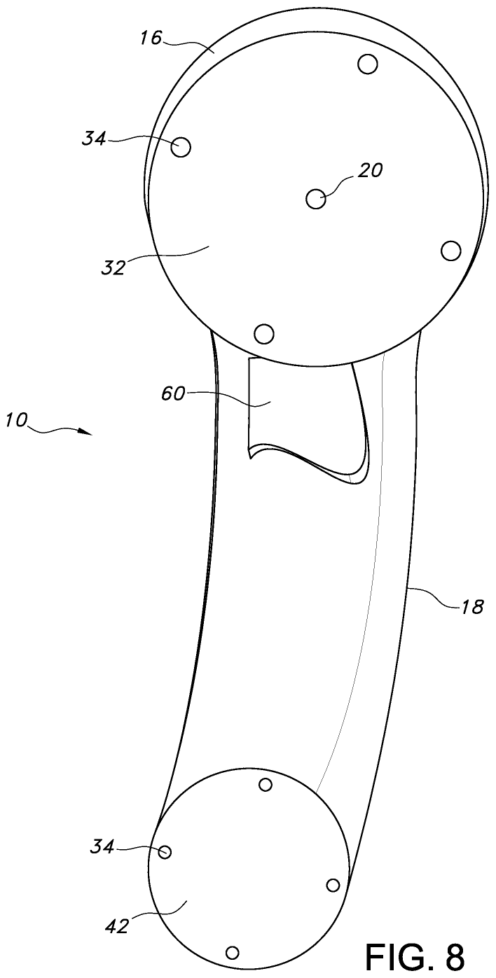

Specifically, and with additional reference to FIG. 4, the longitudinal medial line axis L-L, which extends along the length of the handle 18, forms an angle α with the base axis Y-Y, the angle, for example, is approximately 65 degrees. The angle may be in the range of 10 to 110 degrees, and more particularly in the range of 55 to 75 degrees. As shown in the top view of FIG. 7, the handle 18 also curves laterally to the side. When viewed from the back as shown in FIG. 5, the handle 18 is curved relative to the axis X-X. The handle generally extends along an axis L-L. This axis L-L forms an angle θ with the base axis Y-Y of, for example, approximately 15 degrees. The angle θ may be in the range of 0 to 60 degrees, and more particularly in the range of 5 to 20 degrees. The handle 118 curvature accommodates the normal orientation of a user's extended hand, thereby reducing strain on the hand, wrist, and arm.

The housing 14 may include a plurality of user input devices 50. Such devices 50 may be in the form of buttons, wheels, roller and/or triggers. The input devices upon activation by a user generate an input signal, in a manner known in the art, which is use to control the computing device. In one embodiment shown for example in FIGS. 1-6, the housing 14 supports a first selector button 52 located on the front surface of the base 16. The first selector button 52 extends over substantially the entire width of the base 16. This allows it to be actuated by a number of fingers. A second and third selector button 54 and 56, are disposed adjacent a side edge of the first selector button 52. The second and third buttons 54 and 56 may be positioned such that they are reachable by a user's finger or thumb. A fourth selector button 57 may be located on the side of the handle 18. A wheel 58 may be located on the base and extend through an opening 59 in the first selector button 52. The wheel 58 may be rotated about its axis in a manner known in the art. A trigger selector 60 may be disposed on a lower surface of the handle adjacent a transition between the base 16 and handle 18. Each of the input devices 50 may be used to generate an input signal to provide differing functionality of the computing device as defined by the computer software.

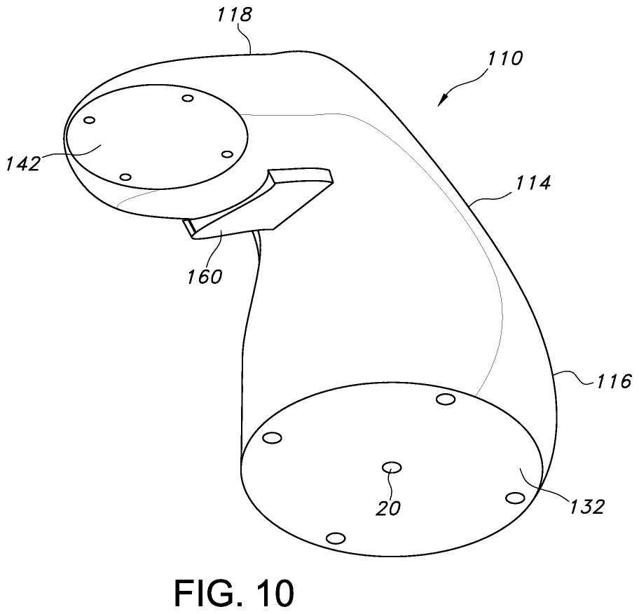

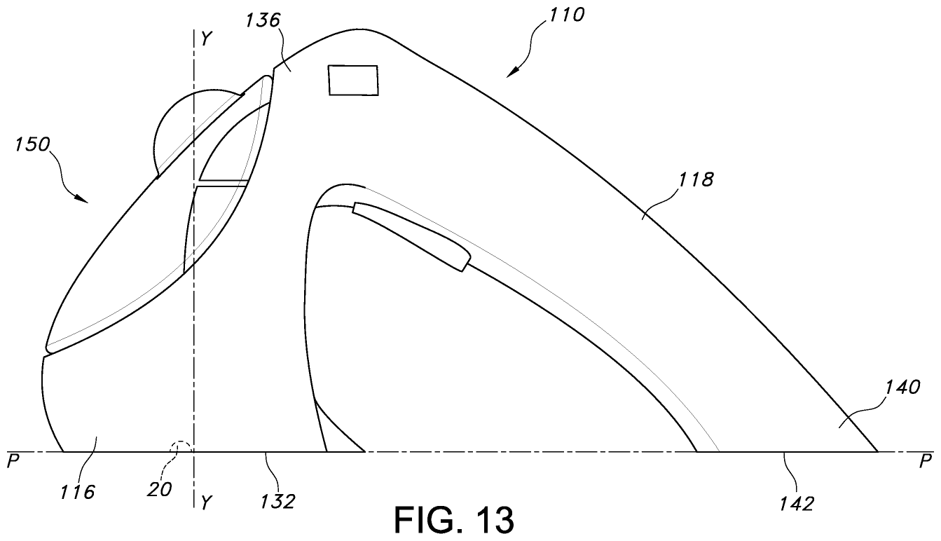

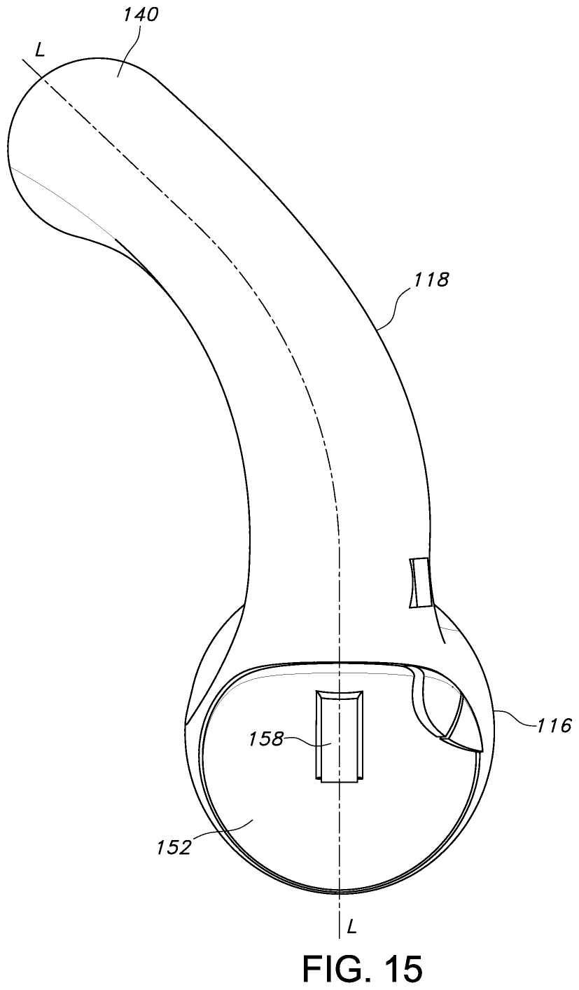

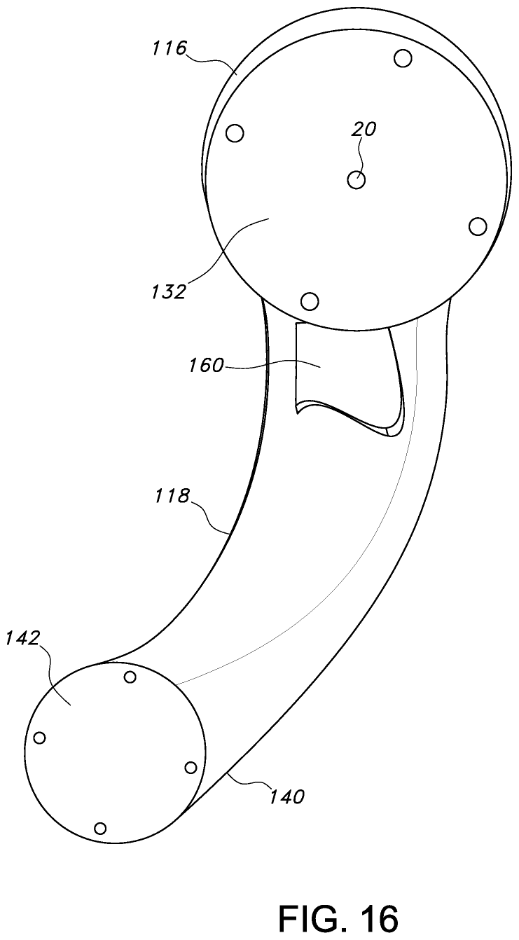

An alternative embodiment of the mouse device 110 is shown in FIGS. 10-16. The mouse device 110 is similar to the embodiment described above, but includes a variation in the configuration of the handle 118 and base 116. As in the previously described embodiment, the housing 114 includes therein a motion sensor 20 that generates a signal responsive to the movement of the mouse 110. As shown in FIGS. 10 and 16, the housing base 116 includes a sensing surface 132 adapted to contact and traverse over the support surface 22. The sensing surface 132 may have a round configuration. However, it is within the contemplation of this disclosure that the configuration of the sensing surface may be formed in a variety of shapes. With reference to FIG. 13, the sensing surface 132 lies in a plane P having a base axis Y-Y extending orthogonally therethrough. The base axis Y-Y extends along a direction of the height of the base 116. The sensor 20 is disposed in the housing 114 adjacent the sensing surface 132. The sensing surface is adapted to slide over a support surface such as a mouse pad. The sensing surface 132 may include friction-reducing pads 134 secured thereto to assist the mouse to be moved along the support surface.

The base 116 narrows as it extends upwardly from the sensing surface 132 to its upper portion 136. A back side of the base 116 has a concave surface 138, which accommodates a user's fingers as the handle 118 is engaged. The elongate handle 118 extends from the base upper portion and provides a gripping element for the user to hold and manipulate the mouse device 110. The handle 118 may have a generally round cross-section to facilitate the comfortable engagement by a user. The handle 118 extends along a longitudinal axis L-L from the base 116 toward a handle distal end 140. The distal end 140 has planar distal surface 142 that lies in the same plane P as the sensing surface 132. Accordingly, the mouse 110 is supported by both the sensing surface 132 and distal surface 142 on the support surface 122 when the mouse 110 is in use. By supporting the mouse 110 at two spaced locations, stress on the user's hand and arm is reduced.

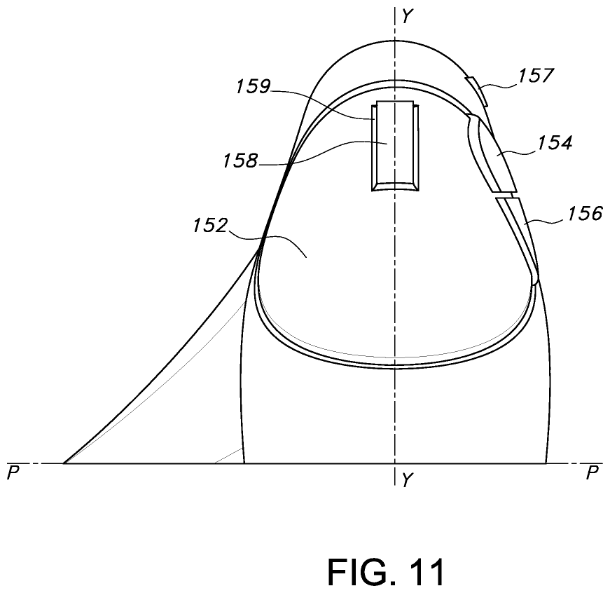

With reference to FIGS. 11-15, the handle 118 curves both downwardly and laterally as it extends from the base 116 to the distal end 140. Thus, the handle curvature is along two distinct axes. One degree of curvature is relative to an axis X-X lying along the sensing plane P. A second degree of curvature is relative to the base axis Y-Y, which is orthogonal to the X-X axis. In other words, the handle curves downwardly toward plane P (curvature in the Y axis) and curves laterally (curvature in the X axis) when viewed from the back or front of the mouse 110. The curvature of the handle 118 thus is helical-like in shape as it curves to a side in an arcuate manner as it extends downwardly and outwardly from the base. The handle curvature is greater than that shown in the previously described embodiment. This curvature conforms to a comfortable ergonomic orientation of a user's hand and arm, thereby permitting ease of mouse operation over long periods of time.

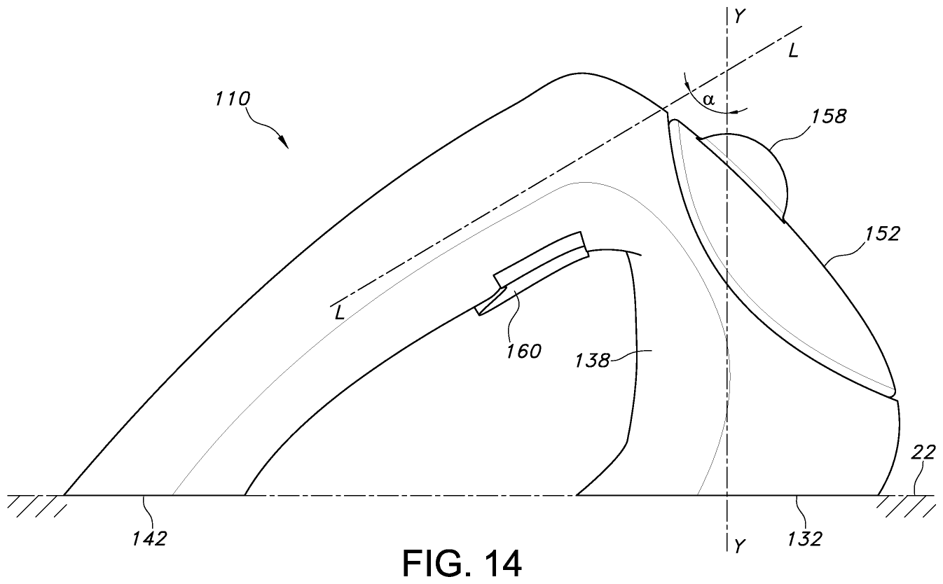

Specifically and with reference to FIG. 14, the longitudinal axis L-L forms an angle α with the base axis Y-Y, the angle being, for example, approximately 55 degrees. The angle α may be in the range of 10 to 100 degrees, and more particularly in the range of 45 to 65 degrees. As shown in FIG. 12, the handle 118 also curves to the side. The amount of curvature results in the handle distal end 140 extending beyond the width of the base 116. When viewed from the back as shown in FIG. 12, the handle 118 is curved relative to the base axis Y-Y. The handle generally extends along a central axis L-L which follows the curvature of the handle 118. This axis forms an angle θ with the base axis Y-Y of, for example, approximately 35 degrees. The angle θ may be in the range of 0 to 60 degrees, and more particularly in the range of 20 to 40 degrees. The handle curvature accommodates the normal orientation of a user's extended hand, thereby reducing strain on the hand, wrist, and arm.

Similar to the previously described embodiment, the housing 114 may include a plurality of use input devices 150. Such devices may be in the form of buttons, wheels, rollers and/or triggers. In the present embodiment shown for example in FIGS. 10-16, the housing 114 supports a first selector button 152 located on the front surface of the base 116. The first selector button 152 extends over substantially the entire width of the base 116. This allows it to be actuated by a number of fingers. A second and third selector button 154 and 156, is disposed adjacent a side edge of the first selector button 152. The second and third buttons 154 and 156 may be positioned such that they are reachable by a user's finger or thumb. A fourth selector button 157 may be located on the side of the handle 118. A wheel 158 may be located on the base and extend through an opening in the first selector button 152. The wheel 158 may be rotated about its axis in a manner known in the art. A trigger selector 160 may be disposed on a lower surface of the handle adjacent a transition between the base 116 and handle 118. Each of the input devices 150 may be used to provide differing functionality of the computing device as defined by the computer software.

While various embodiments of the present invention are specifically illustrated and/or described herein, it will be appreciated that modifications and variations of the present invention may be effected by those skilled in the art without departing from the spirit and intended scope of the invention.

1. A computer mouse device comprising:
a housing including a base;
the base including a sensing surface adapted to contact and traverse over a support surface, the sensing surface forming a sensing surface plane having a base axis Y-Y extending orthogonally through the sensing surface plane;
the housing including a plurality of user input devices thereon adapted for generating an input signal to a computing device;
a sensor disposed on the base and having a sensing element adapted to be disposed adjacent the support surface, the sensor generating a motion signal responsive to a movement of the housing;
the housing including an output device adapted to be operably connected to the computing device for communicating the motion signal to the computing device; and
the housing further including an elongate handle extending from the base downwardly toward the sensing surface plane toward a handle distal end and wherein the handle distal end has a distal surface that lies on the sensing surface plane and the handle curves along a second handle axis orthogonal to the first handle axis as the handle extends from the base toward the distal end.

2. The computer mouse device as defined in claim 1, wherein the handle extends downwardly toward the sensing surface plane along a first handle axis as the handle extends from the base toward the distal end.

3. (canceled)

4. (canceled)

5. The computer mouse device as defined in claim 1, wherein the base has an upper portion opposed from the sensing surface, and the handle extends from the base upper portion.

6. The computer mouse device as defined in claim 1, wherein the distal surface is a planar and adapted to contact and traverse over the support surface.

7. The computer mouse device as defined in claim 1, wherein the output device includes a wire terminating in a connector, the wire operably connected to the motion sensor.

8. The computer mouse device as defined in claim 2, wherein the output device includes a wireless transmitter operably connected to the sensor and adapted to transmit a signal to the computing device.

9. The computer mouse device as defined in claim 1, wherein sensor includes a transmitter and receiver.

10. The computer mouse device as defined in claim 1, wherein the plurality of user input devices includes a button disposed on a front face of the base

11. The computer mouse device as defined in claim 10, wherein the plurality of user input devices includes a rotatable wheel.

12. The computer mouse device as defined in claim 2, wherein the handle has an arcuate configuration.

13. The computer mouse device as defined in claim 1, wherein, the handle has a longitudinal axis forming an angle with the base axis, the angle being in the range of 10 to 100 degrees.

14. A computer mouse device comprising:
a housing including a base;
the base including a sensing surface adapted to contact and to traverse over a support surface, the sensing surface forming a sensing surface plane having a base axis Y-Y extending orthogonally through the sensing surface plane;
the housing including at least one user input device thereon adapted for generating an input signal to control a computing device;
a sensor disposed on the base and having a sensing element adapted to be disposed adjacent the support surface, the sensor generating a motion signal responsive to a movement of the housing;
the housing including an output device adapted to be operably connected to the computing device for communicating the motion signal to the computing device; and
the housing further including an elongate handle extending from the base toward a handle distal end, the handle curving relative to the orthogonal axis as it extends from the base toward the distal end.
wherein the handle curves along a second axis orthogonal to the first axis as the handle extends from the base toward the distal end.

15. (canceled)

16. The computer mouse device as defined in claim 14, wherein the handle has a distal end with a distal surface that lies on the sensing surface plane.

17. The computer mouse device as defined in claim 14, wherein the base has an upper portion opposed from the sensing surface, and the handles extends from the base upper portion.

18. The computer mouse device as defined in claim 14, wherein the handle has an arcuate configuration.

19. The computer mouse device as defined in claim 14, wherein the output device is selected from the group including a wire terminating in a connector and a wireless transmitter adapted to transmit a signal to control the computing device.

20. A computer mouse device comprising:
a housing including a base;
the base including a sensing surface adapted to contact and to traverse over a support surface, the sensing surface forming a sensing surface plane having a base axis Y-Y extending orthogonally through the sensing surface plane;
the housing including a first user input device thereon adapted for generating an input signal adapted to control a computing device upon operation by a user;
a sensor disposed on the base and having a sensing element adapted to be disposed adjacent the support surface, the sensor generating a motion signal responsive to a movement of the housing;
the housing including an output device adapted to be operably connected to the computing device for communicating the motion signal to the computing device; and
the housing further including an elongate handle extending from the base toward a handle distal end, the handle distal end has a distal surface that lies on the sensing surface plane, the handle extending downwardly toward the sensing surface plane along a first handle axis as the handle extends from the base toward the distal end, and the handle curves along a second handle axis orthogonal to the first handle axis as the handle extends from the base toward the distal end.

21. The computer mouse device as defined in claim 1, wherein the handle has a lower surface in spaced opposition to the support surface when the sensing surface is in contact with the support surface, and the handle lower surface including a user input device disposed thereon.

22. The computer mouse device as defined in claim 1, wherein the base does not curve along the second handle axis.

23. The computer mouse device as defined in claim 1, wherein the handle has a generally round cross-section.

24. The computer mouse device as defined in claim 1, wherein the base has a vertical extent that extends along the base axis Y-Y, the base axis intersecting the first handle axis at a point above the at least one of the plurality of input devices.

25. The computer mouse device as defined in claim 1, wherein the base has a bottom perimeter edge defining the sensing surface and the sensor is disposed on the sensing surface.
